(19) United States
(12) Patent Application Publication
(10) Pub. No.: US 2019/0301971 A1
(43) Pub. Date: Oct. 3, 2019

(54) Automatic System for Processing and Testing Gears

(71) Applicant: Hota Industrial Mfg. Co., Ltd. Taiwan Science Park Branch, Taichung City (TW)

(72) Inventors: Yao-Yi Tsai, Taichung City (TW); Wei-Chih Chang, Taichung City (TW); Chi-Lu Chen, Taichung City (TW); Chung-Yo Lin, Taichung City (TW)

(21) Appl. No.: 15/942,618

(22) Filed: Apr. 2, 2018

(51) Int. Cl. G01M 13/02

(52) U.S. Cl. CPC G01M 13/021

(57) ABSTRACT

An automatic system for processing and testing gears has a processing machine, a testing machine, and a robotic arm. The processing machine has a controller and a gear exchanging platform. The testing machine is connected to the processing machine via wired or wireless signals, and has a calculator and a testing platform. The calculator is connected to the controller via the wired or wireless signals, and the testing platform is electrically connected to the calculator. The robotic arm connects the processing machine and the testing machine, and has at least one claw that is able to move gears from the gear exchanging platform to the testing platform.

### BACKGROUND OF THE INVENTION

### 1. Field of the Invention

The present invention relates to an automatic system for processing and testing gears, and more particularly to an automatic system that can instantly correct parameters by tested deviations.

### 2. Description of Related Art

In gear manufacturing, after processed by a processing machine, gear workpieces are sampled by hand and examined on a testing machine. According to deviations which may be found from the examination, workers go to the processing machine and adjust relative parameters of manufacturing.

However, the manufacturing by such process has the following shortcomings.

1. Considerable time and human power are wasted in the repetitive sampling and testing of gears.

2. Furthermore, the manually-done parameter adjustment is unable to be done synchronously as soon as the deviations are reported.

3. To sum up, the manufacturing hardly performs well in both yield rate and efficiency.

### SUMMARY OF THE INVENTION

The main objective of the present invention is to provide an automatic system that improves the yield rate and the efficiency, and is automatic, prompt and precise.

The automatic system for processing and testing gears comprises a processing machine, a testing machine, and a robotic arm. The processing machine has a controller and a gear exchanging platform. The testing machine is connected to the processing machine via wired or wireless signals, and has a calculator and a testing platform. The calculator is connected to the controller via the wired or wireless signals, and the testing platform is electrically connected to the calculator. The robotic arm is connected to the processing machine and the testing machine, and has at least one claw that is able to move gears from the gear exchanging platform to the testing platform.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an automatic system for processing and testing gears in accordance with the present invention;

FIG. 2 is an enlarged and operational perspective view of the automatic system in FIG. 1;

FIG. 3 is a block diagram to show connecting relations within the automatic system in FIG. 1; and

FIG. 4 is a flow chart to show a working procedure of the automatic system in FIG. 1.

### DETAILED DESCRIPTION OF THE PREFERRED EMBODIMENT

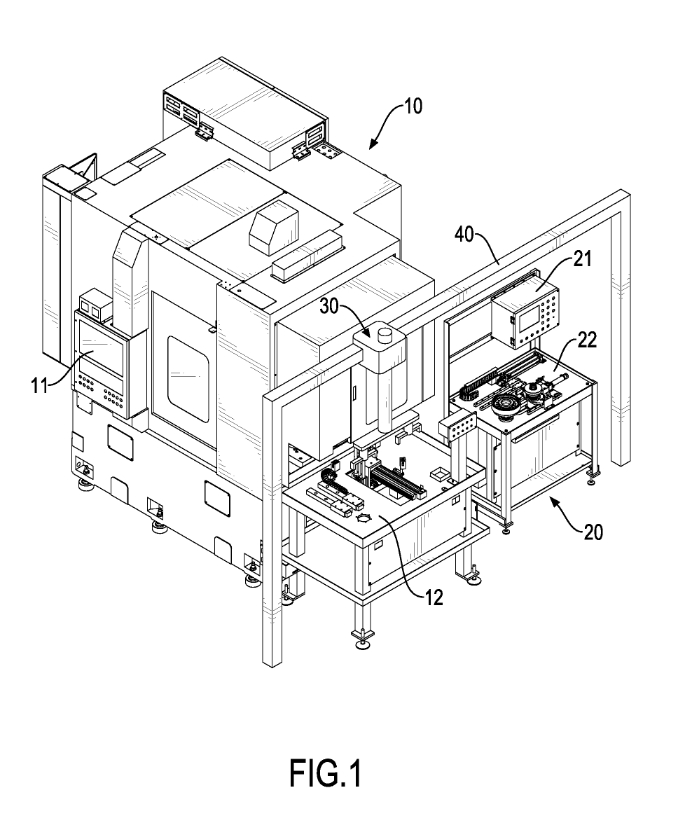

With reference to FIG. 1, an automatic system for processing and testing gears comprises a processing machine 10, a testing machine 20, and a robotic arm 30.

The processing machine 10 is to perform a hobbing process or a grinding process on gears. Technical features of such processes are prior arts, so detailed description will be omitted. The processing machine 10 has a controller 11 and a gear exchanging platform 12. The controller 11 is disposed on the processing machine 10, and is used to control manufacturing programs and adjust relative parameters. The gear exchanging platform 12 is disposed beside the controller 11 of the processing machine 10. Raw gears and processed gears are both disposed on the gear exchanging platform 12 for feeding or further testing.

The testing machine 20 is to perform a roll test on gears. The testing machine 20 is connected to the processing machine 10 via either wired or wireless signals, and comprises a calculator 21 and a testing platform 22. The calculator 21 is disposed on the testing machine 20, and is connected to the controller 11 via wired or wireless signals. Therefore, deviations may be calculated according to measures offered by the testing process, and may be further inputted into the controller 11 via a feedback signal by the calculator 21. The feedback signal enables the controller 11 to correct and compensate parameters automatically. The testing platform 22 is used to perform the roll test on gears, and is connected to the calculator 21. How the roll test is performed pertains to general knowledge in the art, so detailed description thereof will be omitted.

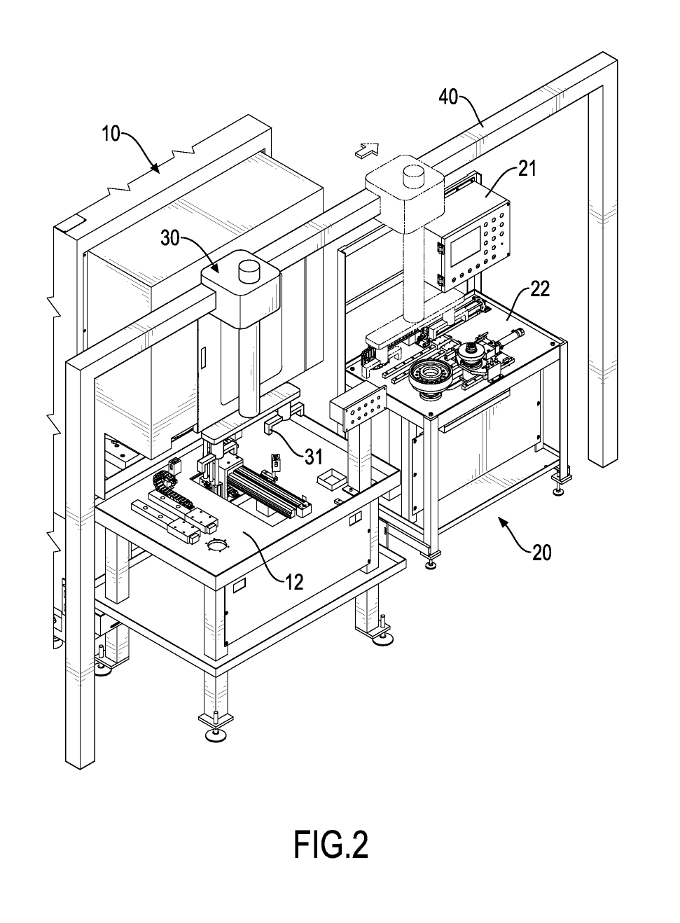

With reference to FIG. 2, the robotic arm 30 is connected to a slideway 40, and moves along the slideway 40 located above the gear exchanging platform 12 and the testing platform 22. The robotic arm 30 has at least one claw 31. The at least one claw 31 is used to move the unexamined processed gears from the gear exchanging platform 12 to the testing platform 22, along the slideway 40, so the roll test may be performed.

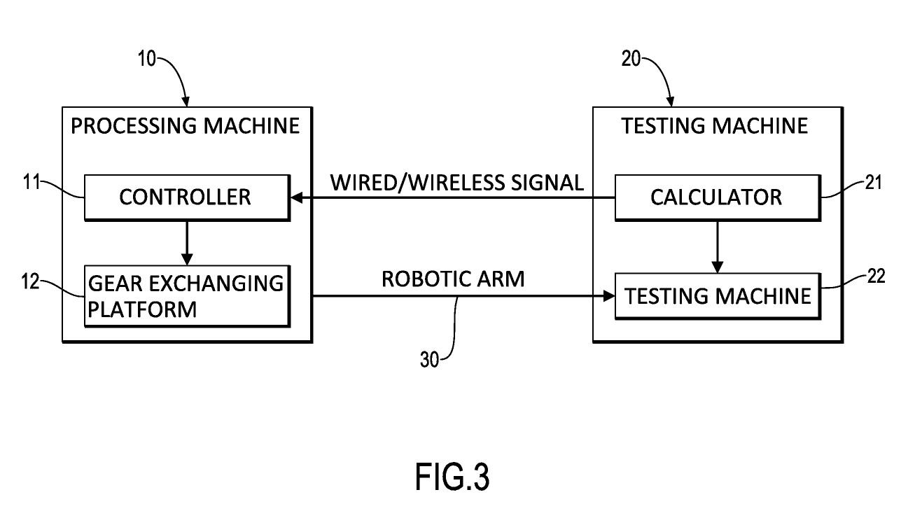

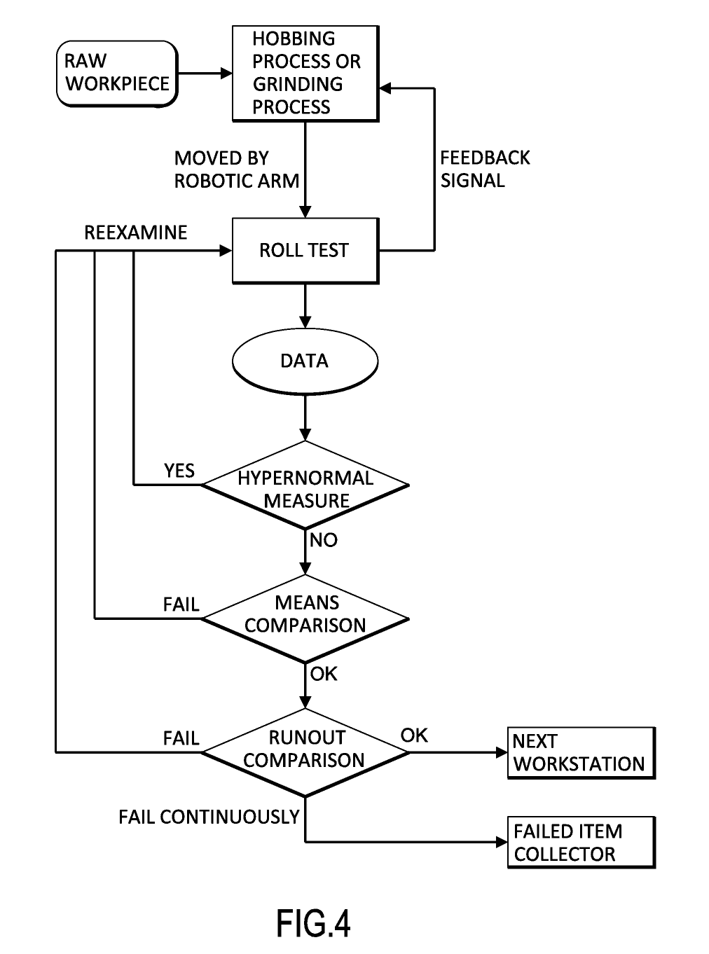

With reference to FIGS. 3 and 4, detailed operating procedures to produce a gear are as follows. First, the processing machine 10 practices the hobbing process or grinding process on gear workpieces, according to initial parameters recorded in the controller 11. The processed gear workpieces are disposed on the gear exchanging platform 12, and are further moved to the testing platform 22 by the at least one claw 31.

In the roll test, the calculator 21 checks the data of a series of measures on at least three examinations: hypernormal measure examination, means comparison, and runout comparison. In addition, the hypernormal measure examination is to check whether an irregular measure exists within the data of a tested gear; if so, then the tested gear is unacceptable and thus fails the hypernormal measure examination. The means comparison indicates that if a measure of a tested gear highly deviates from a mean value that comes out of the same measure of other gears, then the tested gear is unacceptable and thus fails the means comparison. The runout comparison is an examination to measure a maximum difference of distance between teeth of a tested gear and its gear center, and if the maximum difference highly deviates from other values of the distances, then the tested gear is unacceptable and thus fails the runout comparison.

If only a tested gear fails in any one of the three examinations, it should be reexamined and go through the three examinations once again. Moreover, gears which experience continuous failure will be categorized into a failed item collector; gears passing every examination will go to next workstation. Furthermore, the controller 11 will be informed with deviations calculated in the examinations, via a feedback signal, so the controller 11 may adjust manufacturing parameters based on the deviations, and compensate the process of the processing machine 10. As a result, later productions may be manufactured more precisely so as to improve the yield rate of the processing machine 10.

With the aforementioned technical characteristics, the automatic system for processing and testing gears has the following advantages.

1. The robotic arm 30 simplifies the gear moving task used to be executed by humans, and the wired/wireless signals help correct manufacturing parameters automatically. Therefore, the present invention is automatic, rather than depending on human power.

2. The signals travel much faster than people, so the present invention is able to adjust parameters promptly. Also, instant correction leads to precise manufacture.

3. Consequently, as a precise and a time-saving system, the present invention increases the yield rate and the efficiency of gear manufacturing.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An automatic system for processing and testing gears, the automatic system comprising:
a processing machine having
a controller; and
a gear exchanging platform being separate from the controller;
a testing machine connected to the processing machine via signals, and having
a calculator connected to the controller via signals; and
a testing platform electrically connected to the calculator; and
a robotic arm connected to the processing machine and the testing machine, and having at least one claw capable of moving gears from the gear exchanging platform to the testing platform.

2. The automatic system for processing and testing gears as claimed in claim 1, wherein the processing machine is used to perform a hobbing process.

3. The automatic system for processing and testing gears as claimed in claim 1, wherein the processing machine is used to perform a grinding process.

4. The automatic system for processing and testing gears as claimed in claim 2, wherein the processing machine is used to perform a grinding process.

5. The automatic system for processing and testing gears as claimed in claim 1, wherein the testing machine is used to perform a roll test.

6. The automatic system for processing and testing gears as claimed in claim 2, wherein the testing machine is used to perform a roll test.

7. The automatic system for processing and testing gears as claimed in claim 3, wherein the testing machine is used to perform a roll test.

8. The automatic system for processing and testing gears as claimed in claim 4, wherein the testing machine is used to perform a roll test.

9. The automatic system for processing and testing gears as claimed in claim 1, wherein the robotic arm moves along a slideway located above the gear exchanging platform and the testing platform.

10. The automatic system for processing and testing gears as claimed in claim 2, wherein the robotic arm moves along a slideway located above the gear exchanging platform and the testing platform.

11. The automatic system for processing and testing gears as claimed in claim 3, wherein the robotic arm moves along a slideway located above the gear exchanging platform and the testing platform.

12. The automatic system for processing and testing gears as claimed in claim 4, wherein the robotic arm moves along a slideway located above the gear exchanging platform and the testing platform.

13. The automatic system for processing and testing gears as claimed in claim 5, wherein the robotic arm moves along a slideway located above the gear exchanging platform and the testing platform.

14. The automatic system for processing and testing gears as claimed in claim 6, wherein the robotic arm moves along a slideway located above the gear exchanging platform and the testing platform.

15. The automatic system for processing and testing gears as claimed in claim 7, wherein the robotic arm moves along a slideway located above the gear exchanging platform and the testing platform.

16. The automatic system for processing and testing gears as claimed in claim 8, wherein the robotic arm moves along a slideway located above the gear exchanging platform and the testing platform.
